(19) United States
(12) Patent Application Publication
(10) Pub. No.: US 2008/0066158 A1
(43) Pub. Date: Mar. 13, 2008

(54) Authorization Decisions with Principal Attributes

(75) Inventors: Blair B. Dillaway, Redmond, WA (US); Brian A. LaMacchia, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/530,429

(22) Filed: Sep. 8, 2006

(51) Int. Cl. H04L 9/32

(52) U.S. Cl. 726/4

(57) ABSTRACT

Authorization descisions may be made based on principal attributes. In an example implementation, a security scheme has a principal-to-attribute binding mechanism that is unified across both token assertions and policy assertions. In another example implementation, conditional access to a resource is based on a principal simultaneously possessing multiple attributes. In yet another example implementation, a principal may be granted access to a resource if the principal possesses at least one value that is included in a defined subset of values for a given attribute.

### BACKGROUND

Computers and other electronic devices are pervasive in the professional and personal lives of people. In professional settings, people exchange and share confidential information during project collaborations. In personal settings, people engage in electronic commerce and the transmission of private information. In these and many other instances, electronic security is deemed to be important.

Electronic security paradigms can keep professional information confidential and personal information private. Electronic security paradigms may involve some level of encryption and/or protection against malware, such as viruses, worms, and spyware. Both encryption of information and protection from malware have historically received significant attention, especially in the last few years.

However, controlling access to information is an equally important aspect of securing the safety of electronic information. This is particularly true for scenarios in which benefits are derived from the sharing and/or transferring of electronic information. In such scenarios, certain people are to be granted access while others are to be excluded.

Access control has been a common feature of shared computers and application servers since the early time-shared systems. There are a number of different approaches that have been used to control access to information. They share a common foundation in combining authentication of the entity requesting access to some resource with a mechanism of authorizing the allowed access. Authentication mechanisms include passwords, Kerberos, and x.509 certificates. Their purpose is to allow a resource-controlling entity to positively identify the requesting entity or information about the entity that it requires.

Authorization examples include access control lists (ACLs) and policy-based mechanisms such as the eXtensible Access Control Markup Language (XACML) or the PrivilEge and Role Management Infrastructure (PERMIS). These mechanisms define what entities may access a given resource, such as files in a file system, hardware devices, database information, and so forth. They perform this authorization by providing a mapping between authenticated information about a requestor and the allowed access to a resource.

As computer systems have become more universally connected over large networks such as the Internet, these mechanisms have proven to be somewhat limited and inflexible in dealing with evolving access control requirements. Systems of geographically dispersed users and computer resources, including those tat span multiple administrative domains, in particular present a number of challenges that are poorly addressed by currently-deployed technology.

### SUMMARY

Authorization decisions may be made based on principal attributes. In an example implementation, a security scheme has a principal-to-attribute binding mechanism that is unified across both token assertions and policy assertions. In another example implementation, conditional access to a resource is based on a principal simultaneously possessing multiple attributes. In yet another example implementation, a principal may be granted access to a resource if the principal possesses at least one value that is included in a defined subset of values for a given attribute.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Moreover, other method, system, scheme, apparatus, device, media, procedure, API, arrangement, protocol, etc. implementations are described herein.

### BRIEF DESCRIPTION OF THE DRAWINGS

The same numbers are used throughout the drawings to reference like and/or corresponding aspects, features, and components.

FIG. 1 is a block diagram illustrating an example general environment in which an example security scheme may be implemented.

FIG. 2 is a block diagram illustrating an example security environment having two devices and a number of example security-related components.

FIG. 3 is a block diagram illustrating the example security environment of FIG. 2 in which example security-related data is exchanged among the security-related components.

FIG. 4 is a block diagram of an example device that may be used for security-related implementations as described herein.

FIG. 5 is a block diagram illustrating an example assertion format for a general security scheme.

FIG. 6 is a block diagram illustrating an example format for a principal-to-attribute binding mechanism.

FIG. 7 is a block diagram of an example security scheme having a unified principal-to-attribute binding mechanism.

FIG. 8 is a block diagram illustrating an example mechanism for conditioning the validity of a fact on a principal simultaneously possessing multiple attributes.

FIG. 9 is a block diagram illustrating an example mechanism for basing an authorization policy on a defined subset of attribute values.

FIG. 10 is a flow diagram that illustrates an example of a method for basing an authorization policy on a defined subset of attribute values.

### DETAILED DESCRIPTION

### Example Security Environments

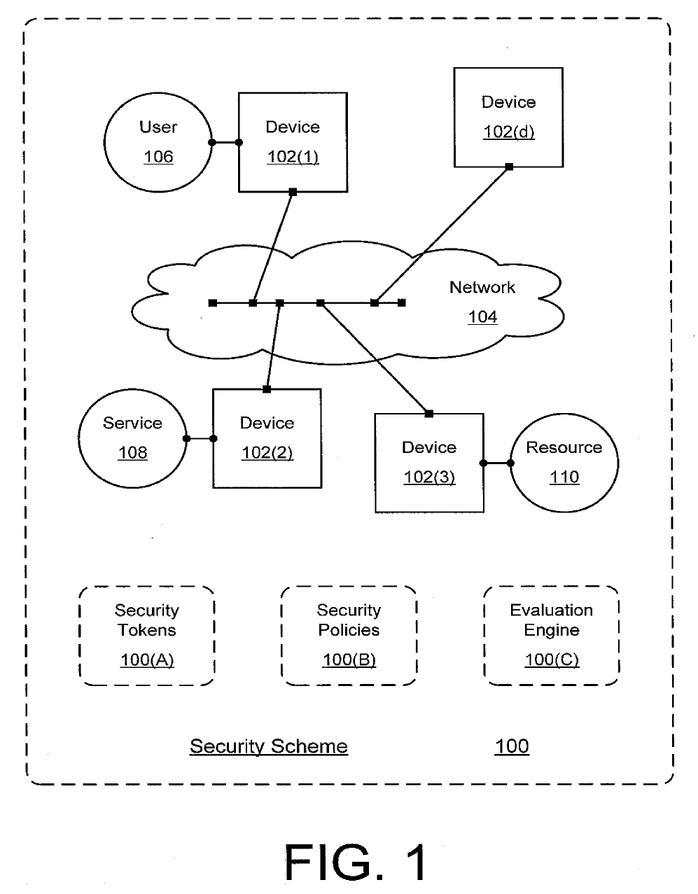

FIG. 1 is a block diagram illustrating an example general environment in which an example security scheme 100 may be implemented. Security scheme 100 represents an integrated approach to security. As illustrated, security scheme 100 includes a number of security concepts: security tokens 100(A), security policies 100(B), and an evaluation engine 100(C). Generally, security tokens 100(A) and security policies 100(B) jointly provide inputs to evaluation engine 100(C). Evaluation engine 100(C) accepts the inputs and produces an authorization output that indicates if access to some resource should be permitted or denied.

In a described implementation, security scheme 100 can be overlaid and/or integrated with one or more devices 102, which can be comprised of hardware, software, firmware, some combination thereof, and so forth. As illustrated, “d” devices, with “d” being some integer, are interconnected over one or more networks 104. More specifically, device 102(1), device 102(2), device 102(3) . . . device 102(d) are capable of communicating over network 104.

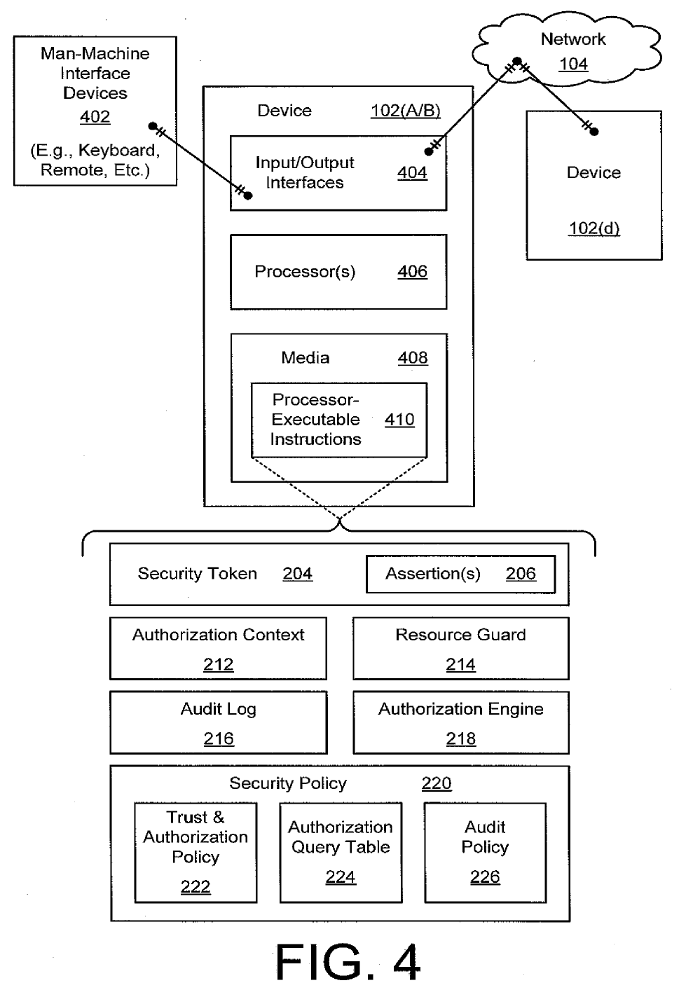

Each device 102 may be any device that is capable of implementing at least a part of security scheme 100. Examples of such devices include, but are not limited to, computers (e.g., a client computer, a server computer, a personal computer, a workstation, a desktop, a laptop, a palm-top, etc.), game machines (e.g., a console, a portable game device, etc.), set-top boxes, televisions, consumer electronics (erg., DVD player/recorders, camcorders, digital video recorders (DVRs), etc.), personal digital assistants (PDAs), mobile phones, portable media players, some combination thereof, and so forth. An example electronic device is described herein below with particular reference to FIG. 4.

Network 104 may be formed from any one or more networks that are linked together and/or overlaid on top of each other. Examples of networks 104 include, but are not limited to, an internet, a telephone network, an Ethernet, a local area network (LAN), a wide area network (WAN), a cable network, a fibre network, a digital subscriber line (DSL) network, a cellular network, a Wi-Fi® network, a WiMAX® network, a virtual private network (VPN), some combination thereof, and so forth. Network 104 may include multiple domains, one or more grid networks, and so forth. Each of these networks or combination of networks may be operating in accordance with any networking standard.

As illustrated, device 102(1) corresponds to a user 106 that is interacting with it. Device 102(2) corresponds to a service 108 that is executing on it. Device 102(3) is associated with a resource 110. Resource 110 may be part of device 102(3) or separate from device 102(3).

User 106, service 108, and a machine such as any given device 102 form a non-exhaustive list of example entities. Entities, from time to time, may wish to access resource 110. Security scheme 100 ensures that entities that are properly authenticated and authorized are permitted to access resource 110 while other entities are prevented from accessing resource 110.

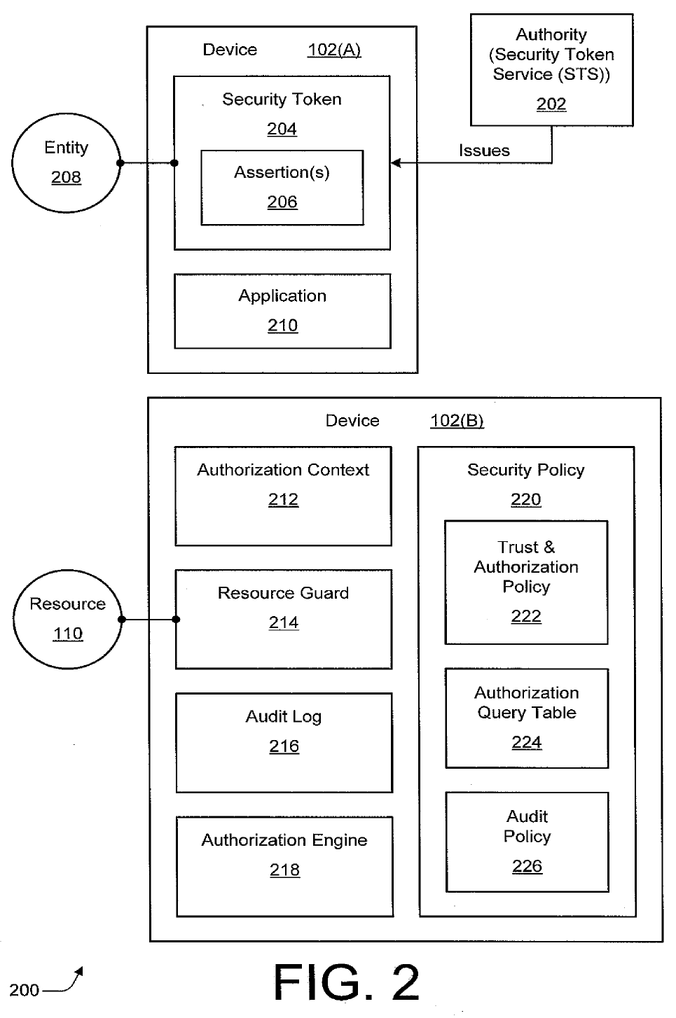

FIG. 2 is a block diagram illustrating an example security environment 200 having two devices 102(A) and 102(B) and a number of example security-related components. Security environment 200 also includes an authority 202, such as a security token service (STS) authority. Device 102(A) corresponds to an entity 208. Device 102(B) is associated wit resource 110. Although a security scheme 100 may be implemented in more complex environments, this relatively-simple two-device security environment 200 is used to describe example security-related components.

As illustrated, device 102(A) includes two security-related components: a security token 204 and an application 210. Security token 204 includes one or more assertions 206. Device 102(B) includes five security-related components: an authorization context 212, a resource guard 214, an audit log 216, an authorization engine 218, and a security policy 220. Security policy 220 includes a trust and authorization policy 222, an authorization query table 224, and an audit policy 226.

Each device 102 may be configured differently and still be capable of implementing all or a part of security scheme 100. For example, device 102(A) may have multiple security tokens 204 and/or applications 210. As another example, device 102(B) may not include an audit log 216 or an audit policy 226. Other configurations are also possible.

In a described implementation, authority 202 issues security token 204 having assertions 206 to entity 208. Assertions 206 are described herein below, including in the section entitled “Security Policy Assertion Language Example Characteristics”. Entity 208 is therefore associated with security token 204. In operation, entity 208 wishes to use application 210 to access resource 110 by virtue of security token 204.

Resource guard 214 receives requests to access resource 110 and effectively manages the authentication and authorization process with the other security-related components of device 102(B). Trust and authorization policy 222, as its name implies, includes policies directed to trusting entities and authorizing actions within security environment 200. Trust and authorization policy 222 may include, for example, security policy assertions (not explicitly shown in FIG. 2). Authorization query table 224 maps requested actions, such as access requests, to an appropriate authorization query. Audit policy 226 delineates audit responsibilities and audit tasks related to implementing security scheme 100 in security environment 200.

Authorization context 212 collects assertions 206 from security token 204, which is/are used to authenticate the requesting entity, and security policy assertions from trust and authorization policy 222. These collected assertions in authorization context 212 form an assertion context. Hence, authorization context 212 may include other information in addition to the various assertions.

The assertion context from authorization context 212 and an authorization query from authorization query table 224 are provided to authorization engine 218. Using the assertion context and the authorization query, authorization engine 218 makes an authorization decision. Resource guard 214 responds to the access request based on the authorization decision. Audit log 216 contains audit information such as, for example, identification of the requested resource 110 and/or the algorithmic evaluation logic performed by authorization engine 218.

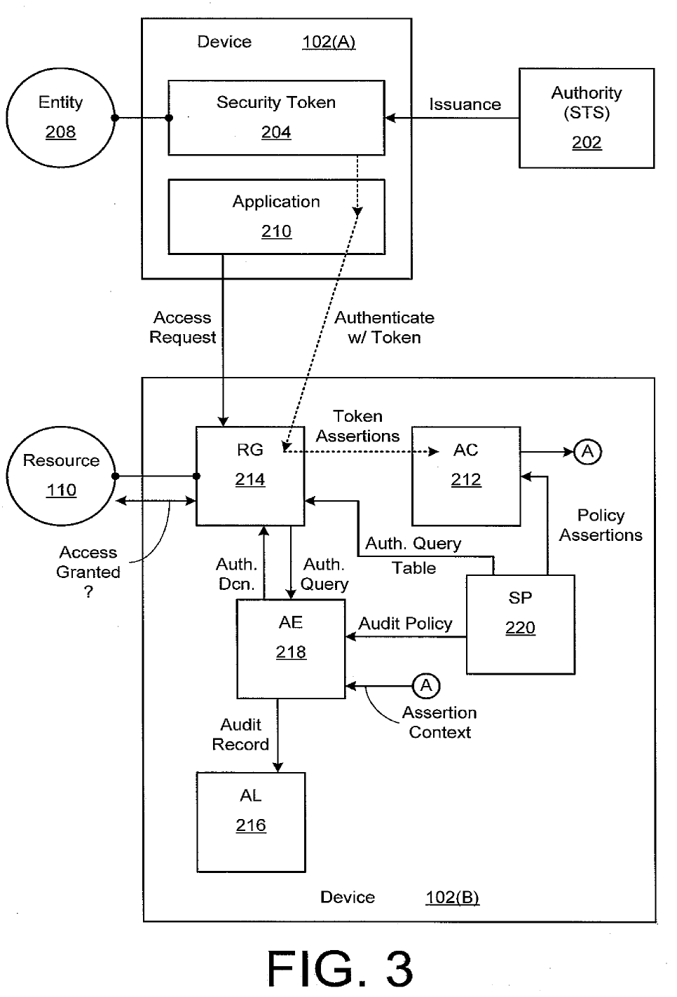

FIG. 3 is a block diagram illustrating example security environment 200 in which example security-related data is exchanged among the security-related components. The security-related data is exchanged in support of an example access request operation. In this example access request operation, entity 208 wishes to access resource 110 using application 210 and indicates its authorization to do so with security token 204. Hence, application 210 sends an access request* to resource guard 214. In this description of FIG. 3, an asterisk (i.e., “*”) indicates that the stated security-related data is explicitly indicated in FIG. 3.

In a described implementation, entity 208 authenticates* itself to resource guard 214 with a token*, security token 204. Resource guard 214 forwards the token assertions* to authorization context 212. These token assertions are assertions 206 (of FIG. 2) of security token 204. Security policy 220 provides the authorization query table* to resource guard 214. The authorization query table derives from authorization query table module 224. The authorization query table sent to resource guard 214 may be confined to the portion or portions directly related to the current access request.

Policy assertions are extracted from trust and authorization policy 222 by security policy 220. The policy assertions may include both trust-related assertions and authorization-related assertions. Security policy 220 forwards the policy assertions* to authorization context 212. Authorization context 212 combines the token assertions and the policy assertions into an assertion context. The assertion context* is provided from authorization context 212 to authorization engine 218 as indicated by the encircled “A”.

An authorization query is ascertained from the authorization query table. Resource guard 214 provides the authorization query (auth. query*) to authorization engine 218. Authorization engine 218 uses the authorization query and the assertion context in an evaluation algorithm to produce an authorization decision. The authorization decision (auth. dcn.*) is returned to resource guard 214. Whether entity 208 is granted access* to resource 110 by resource guard 214 is dependent on the authorization decision. If the authorization decision is affirmative, then access is granted. If, on the other hand, the authorization decision issued by authorization engine 218 is negative, then resource guard 214 does not grant entity 208 access to resource 110.

The authorization process can also be audited using semantics that are complementary to the authorization process. The auditing may entail monitoring of the authorization process and/or the storage of any intermediate and/or final products of, e.g., the evaluation algorithm logically performed by authorization engine 218. To that end, security policy 220 provides to authorization engine 218 an audit policy* from audit policy 226. At least when auditing is requested, an audit record* having audit information may be forwarded from authorization engine 218 to audit log 216. Alternatively, audit information may be routed to audit log 216 via resource guard 214, for example, as part of the authorization decision or separately.

FIG. 4 is a block diagram of an example device 102 tat may be used for security-related implementations as described herein. Multiple devices 102 are capable of communicating across one or more networks 104. As illustrated, two devices 102(A/B) and 102(d) are capable of engaging in communication exchanges via network 104. Although two devices 102 are specifically shown, one or more than two devices 102 may be employed, depending on the implementation.

Generally, a device 102 may represent any computer or processing-capable device, such as a client or server device; a workstation or other general computer device; a PDA; a mobile phone; a gaming platform; an entertainment device; one of the devices listed above with reference to FIG. 1; some combination thereof; and so forth. As illustrated, device 102 includes one or more input/output (I/O) interfaces 404, at least one processor 406, and one or more media 408. Media 408 include processor-executable instructions 410.

In a described implementation of device 102, I/O interfaces 404 may include (i) a network interface for communicating across network 104, (ii) a display device interface for displaying information on a display screen, (iii) one or more man-machine interfaces, and so forth. Examples of (i) network interfaces include a network card, a modem, one or more ports, and so forth. Examples of (ii) display device interfaces include a graphics driver, a graphics card, a hardware or software driver for a screen or monitor, and so forth. Printing device interfaces may similarly be included as part of I/O interfaces 404. Examples of (iii) man-machine interfaces include those that communicate by wire or wirelessly to man-machine interface devices 402 (e.g., a keyboard, a remote, a mouse or other graphical pointing device, etc.).

Generally, processor 406 is capable of executing, performing, and/or otherwise effectuating processor-executable instructions, such as processor-executable instructions 410. Media 408 is comprised of one or more processor-accessible media. In other words, media 408 may include processor-executable instructions 410 that are executable by processor 406 to effectuate the performance of functions by device 102.

Thus, realizations for security-related implementations may be described in the general context of processor-executable instructions. Generally, processor-executable instructions include routines, programs, applications, coding, modules, protocols, objects, components, metadata and definitions thereof, data structures, application programming interfaces (APIs), schema, etc that perform and/or enable particular tasks and/or implement particular abstract data types. Processor-executable instructions may be located in separate storage media, executed by different processors, and/or propagated over or extant on various transmission media.

Processor(s) 406 may be implemented using any applicable processing-capable technology. Media 408 may be any available media that is included as part of and/or accessible by device 102. It includes volatile and non-volatile media, removable and non-removable media, and storage and transmission media (e.g., wireless or wired communication channels). For example, media 408 may include an array of disks/flash memory/optical media for longer-term mass storage of processor-executable instructions 410, random access memory (RAM) for shorter-term storing of instructions that are currently being executed, link(s) on network 104 for transmitting communications (e.g., security-related data), and so forth.

As specifically illustrated, media 408 comprises at least processor-executable instructions 410. Generally, processor-executable instructions 410, when executed by processor 406, enable device 102 to perform the various functions described herein, including those actions that are illustrated in the various flow diagrams. By way of example only, processor-executable instructions 410 may include a security token 204, at least one of its assertions 206, an authorization context module 212, a resource guard 214, an audit log 216, an authorization engine 218, a security policy 220 (e.g., a trust and authorization policy 222, an authorization query table 224, and/or an audit policy 226, etc.), some combination thereof, and so forth. Although not explicitly shown in FIG. 4, processor-executable instructions 410 may also include an application 210 and/or a resource 110.

### Security Policy Assertion Language Example Characteristics

This section describes example characteristics of an implementation of a security policy assertion language (SecPAL). The SecPAL implementation of this section is described in a relatively informal manner and by way of example only. It has an ability to address a wide spectrum of security policy and security token obligations involved in creating an end-to-end solution. These security policy and security token obligations include, by way of example but not limitation: describing explicit trust relationships; expressing security token issuance policies; providing security tokens containing identities, attributes, capabilities, and/or delegation policies; expressing resource authorization and delegation policies; and so forth.

In a described implementation, SecPAL is a declarative, logic-based language for expressing security in a flexible and tractable manner. It can be comprehensive, and it can provide a uniform mechanism for expressing trust relationships, authorization policies, delegation policies, identity and attribute assertions, capability assertions, revocations, audit requirements, and so forth. This uniformity provides tangible benefits in terms of making the security scheme understandable and analyzable. The uniform mechanism also improves security assurance by allowing one to avoid, or at least significantly curtail, the need for semantic translation and reconciliation between disparate security technologies.

A SecPAL implementation may include any of the following example features: [1] SecPAL can be relatively easy to understand. It may use a definitional syntax that allows its assertions to be read as English-language sentences. Also, its grammar may be restrictive such that it requires users to understand only a few subject-verb-object (e.g., subject-verb phrase) constructs with cleanly defined semantics. Finally, the algorithm for evaluating the deducible facts based on a collection of assertions may rely on a small number of relatively simple rules.

[2] SecPAL can leverage industry standard infrastructure in its implementation to ease its adoption and integration into existing systems. For example, an extensible markup language (XML) syntax may be used that is a straightforward mapping from the formal model. This enables use of standard parsers and syntactic correctness validation tools. It also allows use of the W3C XML Digital Signature and Encryption standards for integrity, proof of origin, and confidentiality.

[3] SecPAL may enable distributed policy management by supporting distributed policy authoring and composition. This allows flexible adaptation to different operational models governing where policies, or portions of policies, are authored based on assigned administrative duties. Use of standard approaches to digitally signing and encrypting policy objects allow for their secure distribution. [4] SecPAL enables an efficient and safe evaluation. Simple syntactic checks on the inputs are sufficient to ensure evaluations will terminate and produce correct answers.

[5] SecPAL can provide a complete solution for access control requirements supporting required policies, authorization decisions, auditing, and a public-key infrastructure (PKI) for identity management. In contrast, most other approaches only manage to focus on and address one subset of the spectrum of security issues. [6] SecPAL may be sufficiently expressive for a number of purposes, including, but not limited to, handling the security issues for Grid environments and other types of distributed systems. Extensibility is enabled in ways that maintain the language semantics and evaluation properties while allowing adaptation to the needs of specific systems.

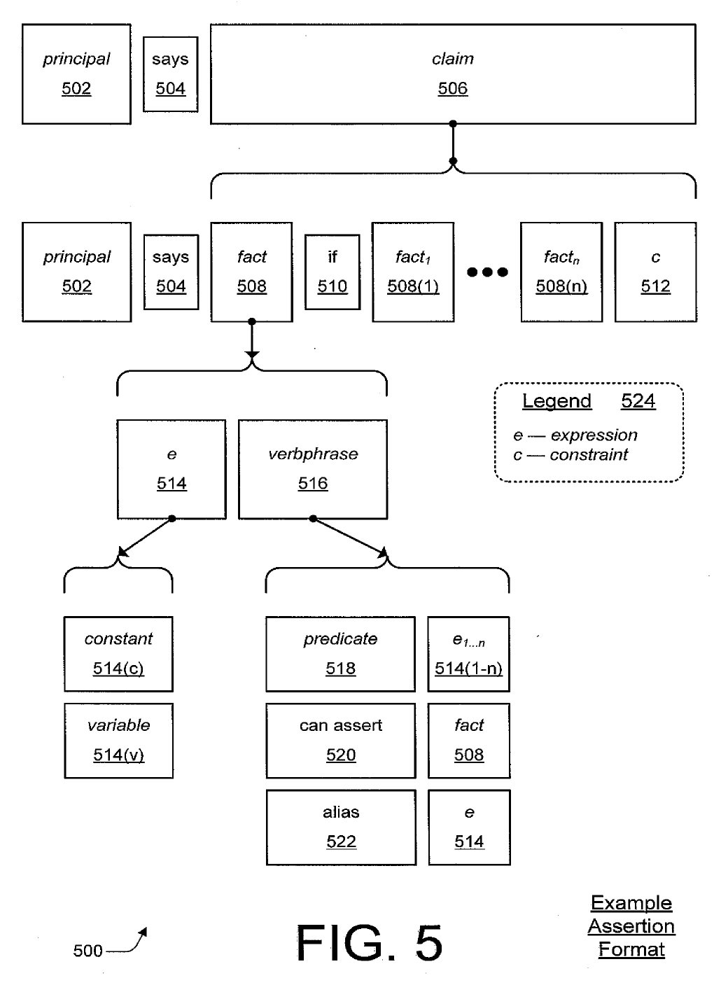

FIG. 5 is a block diagram illustrating an example assertion format 500 for a general security scheme. Security scheme assertions that are used in the implementations described otherwise herein may differ from example assertion format 500. However, assertion format 500 is a basic illustration of one example format for security scheme assertions, and it provides a basis for understanding example described implementation of various aspects of a general security scheme.

As illustrated at the top row of assertion format 500, an example assertion at a broad level includes: a principal portion 502, a says portion 504, and a claim portion 506. Textually, the broad level of assertion format 500 may be represented by: principal says claim.

At the next row of assertion format 500, claim portion 506 is separated into example constituent parts. Hence, an example claim portion 506 includes: a fact portion 508, an if portion 510, “n” conditional fact_{1 . . . n} portions 508(1 . . . n), and a c portion 512. The subscript “n”, represents some integer value. As indicated by legend 524, c portion 512 represents a constraint portion. Although only a single constraint is illustrated, c portion 512 may actually represent multiple constraints (e.g., c₁, . . . , cₘ). The set of conditional fact portions 508(1 . . . n) and constraints 512(1 . . . m) on the right-hand side of if portion 510 may be termed the antecedent.

Textually, claim portion 506 may be represented by: fact if fact₁, . . . , factₙ, c. Hence, the overall assertion format 500 may be represented textually as follows: principal says fact if fact₁, . . . , factsₙ, c. However, an assertion may be as simple as: principal says fact. In this abbreviated, three-part version of an assertion, the conditional portion that starts with if portion 510 and extends to c portion 512 is omitted.

Each fact portion 508 may also be further subdivided into its constituent parts. Example constituent parts are: an e portion 514 and a verb phrase portion 516. As indicated by legend 524, e portion 514 represents an expression portion. Textually, a fact portion 508 may be represented by: e verbphrase.

Each e or expression portion 514 may take on one of two example options. These two example expression options are: a constant 514(c) and a variable 514(v). Principals may fall under constants 514(c) and/or variables 514(v).

Each verb phrase portion 516 may also take on one of three example options. These three example verb phrase options are: a predicate portion 518 followed by one or more e_{1 . . . n} portions 514(1 . . . n), a can assert portion 520 followed by a fact portion 508, and an alias portion 522 followed by an expression portion 514. Textually, these three verb phrase options may be represented by: predicate e₁ . . . eₙ, can assert fact, and alias e, respectively. The integer “n” may take different values for facts 508(1 . . . n) and expressions 514(1 . . . n).

Generally, SecPAL statements are in the form of assertions made by a security principal. Security principals are typically identified by cryptographic keys so that they can be authenticated across system boundaries. In their simplest form, an assertion states that the principal believes a fact is valid (e.g., as represented by a claim 506 that includes a fact portion 508). They may also state a fact is valid if one or more other facts are valid and some set of conditions are satisfied (e.g., as represented by a claim 506 that extends from a fact portion 508 to an if portion 510 to conditional fact portions 508(1 . . . n) to a c portion 512). There may also be conditional facts 508(1 . . . n) without any constraints 512 and/or constraints 512 without any conditional facts 508(1 . . . n).

In a described implementation, facts are statements about a principal. Four example types of fact statements are described here in this section. First, a fact can state that a principal has the right to exercise an action(s) on a resource with an “action verb”. Example action verbs include, but are not limited to, call, send, read, list, execute, write, modify, append, delete, install, own, and so forth. Resources may be identified by universal resource indicators (URIs) or any other approach.

Second, a fact can express the binding between a principal identifier and one or more attribute(s) using the “possess” verb. Example attributes include, but are not limited to, email name, common name, group name, role title, account name, domain name server/service (DNS) name, internet protocol (IP) address, device name, application name, organization name, service name, account identification/identifier (ID), and so forth. An example third type of fact is that two principal identifiers can be defined to represent the same principal using the “alias” verb.

“Qualifiers” or fact qualifiers may be included as part of any of the above three fact types. Qualifiers enable an assertor to indicate environmental parameters (e.g., time, principal location, etc.) that it believes should hold if the fact is to be considered valid. Such statements may be cleanly separated between the assertor and a relying party's validity checks based on these qualifier values.

An example fourth type of fact is defined by the “can assert” verb. This “can assert” verb provides a flexible and powerful mechanism for expressing trust relationships and delegations. For example, it allows one principal (A) to state its willingness to believe certain types of facts asserted by a second principal (B). For instance, given the assertions “A says B can assert fact0” and “B says fact0”, it can be concluded that A believes fact0 to be valid and therefore it can be deduced that “A says fact0”.

Such trust and delegation assertions may be (i) unbounded and transitive to permit downstream delegation or (ii) bounded to preclude downstream delegation. Although qualifiers can be applied to “can assert” type facts, omitting support for qualifiers to these “can assert” type facts can significantly simplify the semantics and evaluation safety properties of a given security scheme.

In a described implementation, concrete facts can be stated, or policy expressions may be written using variables. The variables are typed and may either be unrestricted (e.g., allowed to match any concrete value of the correct type) or restricted (e.g., required to match a subset of concrete values based on a specified pattern).

Security authorization decisions are based on an evaluation algorithm (e.g., that may be conducted at authorization engine 218) of an authorization query against a collection of assertions (e.g., an assertion context) from applicable security policies (e.g., a security policy 220) and security tokens (e.g., one or more security tokens 204). Authorization queries are logical expressions, which may become quite complex, that combine facts and/or conditions. These logical expressions may include, for example, AND, OR, and/or NOT logical operations on facts, either with or without attendant conditions and/or constraints.

This approach to authorization queries provides a flexible mechanism for defining what must be known and valid before a given action is authorized. Query templates (e.g., from authorization query table 224) form a part of the overall security scheme and allow the appropriate authorization query to be declaratively stated for different types of access requests and other operations/actions.

### Example Implementations for Authorization Decisions with Principal Attributes

It can be useful in security systems to deal with attributes of principals rather than just their identities. This allows one to write authorization policies in terms of various logical groups such as: users with email addresses in the same domain, members of the same organization, workers on a project, people with the same gender, and so forth. To make such authorization policies useful, there should be some mechanism to express such attributes and to indicate who is asserting which attributes are bound to a given principal. It can also be beneficial if the policy and the tokens use a consistent encoding to avoid semantic translations and the errors that can result from translations.

Existing approaches to meeting these needs have limitations that limit their flexibility and introduce potential sources of errors. Commonly-used Kerberos tokens lack a well defined structure for carrying general attribute information and basically carry only opaque security identifiers. These must be mapped externally to human understandable identities and attributes, which is a potential source of errors. Kerberos tokens are commonly used with Access Control Lists (ACLs) to express a security policy. While ACLs can directly use the opaque identifiers, they must still be mapped to allow users to effectively set them.

X.509 certificates were primarily designed to carry naming attributes in the form of a Distinguished Name (DN). This can encode a common name, an organization, a country, and so forth. DNs are also commonly used to carry email name information. Attribute certificates (e.g., those in accordance with RFC 3281) are a more generic way of carrying attribute information within the X.509 framework. This remains, however, an inadequate solution as there is no corresponding authorization policy mechanisms defined.

If one is using ACLs, then one must map from the attribute encoding to an opaque identifier that can be placed within the ACL. Other policy approaches such as Authorization Manager® from Microsoft® Corp., XACML, etc. have independently defined attribute encodings that typically differ from those used in X.509 and attribute certificates. Consequently, one must map from the attribute encoding mechanism This mapping can be complex and introduce subtle errors into the overall system.

The rights language ISO MPEG REL (hereafter REL) defines a uniform way of making assertions about a principal's attributes and access control policies that use those attributes. This can eliminate the potential mapping errors. However, the REL approach still has limitations in that it fails to define a standard approach to encoding specific attributes (an attribute may be any arbitrary subtype of the REL-defined Resource type). There is also no way to allow efficient grouping of attributes for a given principal. Together, these limitations can make it difficult to understand the attributes associated with a given principal, and they can introduce errors in the encoding of such information.

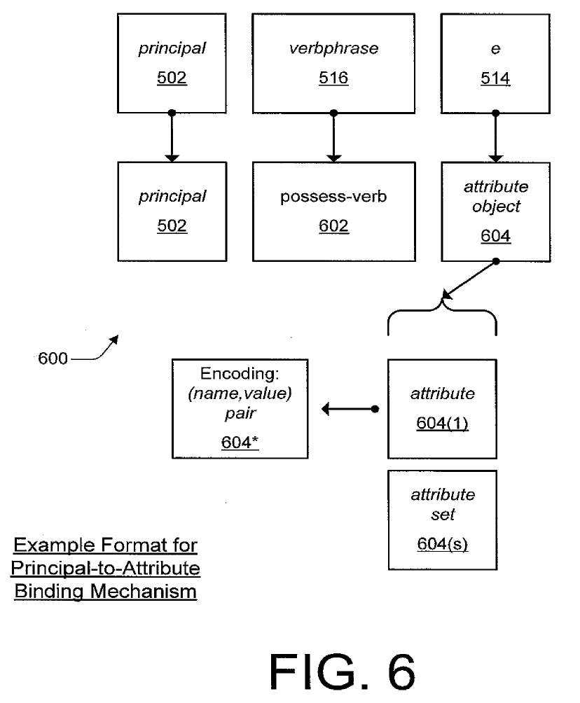

FIG. 6 is a block diagram illustrating an example format for a principal-to-attribute binding mechanism 600. As illustrated, principal-to-attribute binding mechanism 600 includes a principal portion 502, a verb phrase portion 516, and an expression portion 514. These portions 502, 516, and 514 are introduced herein above with reference to FIG. 5. Principal portion 502 may be a constant 514(c) or a variable 514(v) (both of FIG. 5).

In a described implementation, principal-to-attribute binding mechanism 600 is an example embodiment of a fact portion 508 (of FIG. 5), with fact portion 508 having the following format: principal portion 502-verb phrase portion 516-expression portion 514, or principal verbphrase e. For principal-to-attribute binding mechanism 600, principal portion 502 is realized as a principal portion 502, verb phrase portion 516 is realized as a possess-verb portion 602, and expression portion 514 is realized as an attribute object portion 604. A principal-to-attribute binding mechanism 600 may thus comport with a form of:

principal possess-verb attribute-object.

Possess-verb 602 may be any verb representing possession. Examples include, by way of example but not limitation, “possess”, “has”, “holds”, “owns”, “retains”, “bears”, and so forth. Possess-verb 602 indicates that principal 502 has or possesses the attribute or attributes of attribute object 604.

Attribute object 604 may be one attribute 604(1) or a set of attributes 604(s). The positive integer “s” represents the number of attributes included in attribute set 604(s). In an example encoding approach, attribute object portion 604 is encoded as an (attribute name, attribute value) pair 604*, or more succinctly (name, value) pair 604*. As part of principal-to-attribute binding mechanism 600, this name-value pair 604* indicates that principal 502 possesses the specified attribute value for the identified attribute name. For example, a principal having an email address of principal_{—}2@company.com may be encoded as “(email address, principal_{—}2@company.com)”.

Thus, in a described implementation, principal-to-attribute binding mechanism 600 enables the expression of principal-attribute bindings in a uniform manner. It can be efficiently encoded, easily extended, and used consistently in both security tokens (e.g., in token assertions) and security policies (e.g., in policy assertions).

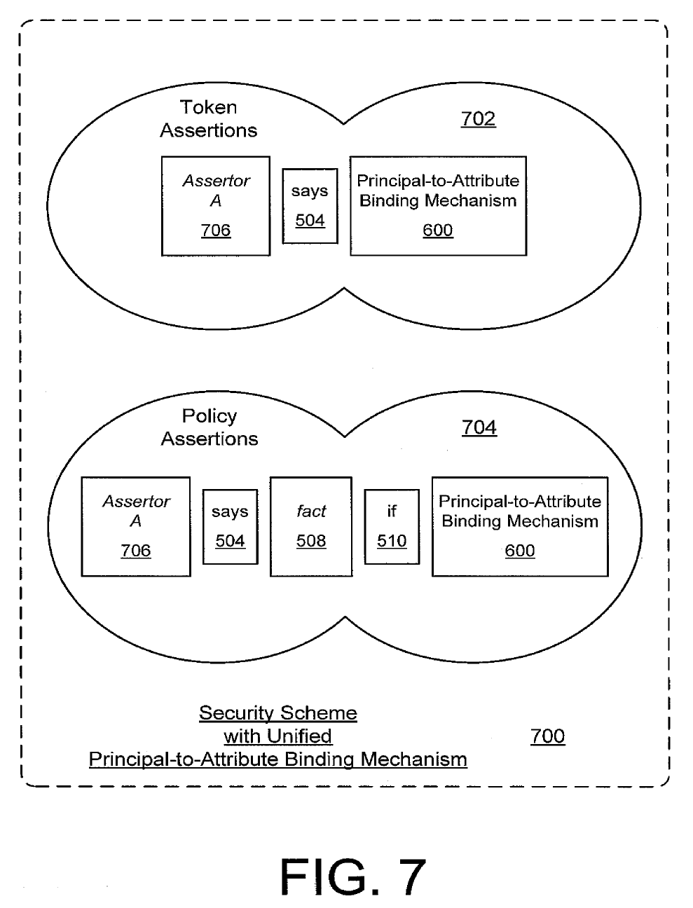

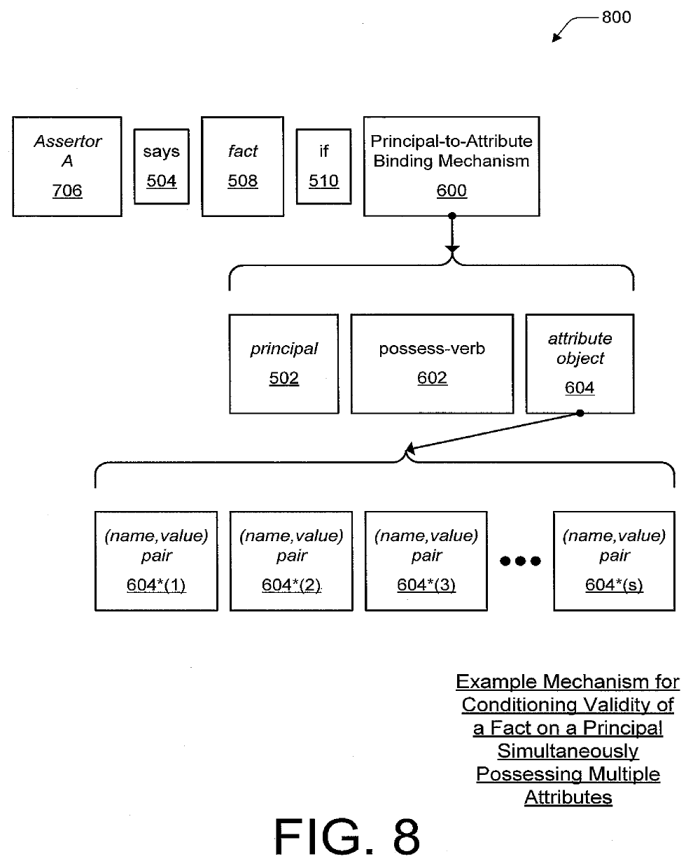

It defines a relatively precise manner for binding an attribute, expressed in a standard way, to a principal. It can also indicate who is asserting that binding. The inclusion of the assertor is briefly described below and described in greater detail herein below with particular reference to FIGS. 7 and 8. Attributes may also be uniformly encoded to ensure understandability. Furthermore, they may also be grouped together to provide a highly efficient encoding of multiple attributes for both security tokens and security policies.

In a described example implementation, an attribute assertion may be encoded in the following form:

A says B possess [attribute|attribute set]

where:

A is the assertor of the attribute binding;

B is the principal subject (e.g., principal 502);

“possess” is the predicate indicating an attribute binding is being declared (e.g., possess-verb 602); and

the attribute object is either a single attribute or a set of attributes (e.g., attribute object 604).

Attributes are uniformly encoded as (name, value) pairs (e.g., (name, value) pair 604*). Some examples include, but are not limited to, the following:

(email name, joe@fabrikam.com)—encodes an email address attribute;

(common name, Joe Henry)—encodes a person's name; and

(group name, HR Employees)—encodes membership in an identified group.

An attribute set (e.g., attribute set 604(s)) is a collection of two or more attributes that are bound to the same principal. Thus, using the above three examples, all three attributes can be efficiently encoded as being bound to a single principal B as follows:

A says B possess {(email name, joe@fabrikam.com), (common name, Joe Henry), (group name, HR Employees)},

where the bracket symbols { } indicate an attribute set.

This approach to attribute encoding is usable in a described security assertion language for both security tokens (e.g., token assertions) and security polices (e.g., policy assertions). It avoids the need for mappings between differing representations and semantics of security tokens and security policies that are a common source of errors in conventional approaches to handling different security scenarios with a security language.

FIG. 7 is a block diagram of an example security scheme 700 having a unified principal-to-attribute binding mechanism. As illustrated, security scheme 700 includes token assertions 702 and policy assertions 704. In a described implementation, token assertions 702 may include principal-to-attribute binding mechanism 600. Likewise, policy assertions 704 may include principal-to-attribute binding mechanism 600.

Generally, token assertions 702 are used by resource access requesters (e.g., entity 208 of FIG. 2) to provide authentication. Policy assertions 704 are used by resource protectors (e.g., resource guard 214, security policy 220, authorization context 212, and/or authorization engine 218, etc.) to indicate access rights to resources (e.g., resource 110). Token assertions and policy assertions are described generally herein above and may share the same semantic.

A token assertion 702 may include an assertor A portion 706, a says portion 504, and a principal-to-attribute binding mechanism 600. Such a token assertion may follow a form that comports with:

A says principal possess-verb attribute-object.

A policy assertion 704 may include an assertor A portion 706, a says portion 504, a fact portion 508, an if portion 510, and a principal-to-attribute binding mechanism 600. Such a policy assertion may comport with a form of:

A says fact if principal possess-verb attribute-object.

FIG. 8 is a block diagram illustrating an example mechanism 800 for conditioning the validity of a fact on a principal simultaneously possessing multiple attributes. As illustrated at a highest level, conditional access mechanism 800 includes an assertor A portion 706, a says portion 504, a fact portion 508, an if portion 510, and principal-to-attribute binding mechanism 600. Conditional access mechanism 800 is an example of a policy assertion 704. Principal-to-attribute binding mechanism 600 includes a principal portion 502, a possess-verb 602, and an attribute object 604.

In a described implementation, attribute object 604 includes multiple (name, value) pair portions 604*. Specifically, attribute object 604 is illustrated as having “s” name-value pairs 604*, with “s” representing the number of different attribute name-value pairs and being an integer of 2 or greater in a multiple attribute set 604(s). Hence, attribute object 604 includes (name, value) pair portion 604*(1), (name, value) pair portion 604*(2), (name, value) pair portion 604*(3), . . . , (name, value) pair portion 604*(s).

Accordingly, a principal-to-attribute binding mechanism 600, which is part of a conditional access mechanism 800, may be realized as a fact that comports with a form of:

```
principal possess {(attribute name₁, attribute value₁), (attribute
        name₂, attribute value₂), ..., (attribute nameₛ, attribute
        valueₛ)} .
```

The fact presented above may be converted into an assertion that comports with a form of:

```
assertor says principal possess {(attribute name₁, attribute
        value₁), (attribute name₂, attribute value₂), ..., (attribute
        nameₛ, attribute valueₛ)}.
```

### The assertion above indicates that the assertor believes that the principal possesses the multiple attributes (e.g., as represented by “s” attribute name-value pairs 604*(1 . . . s)).

A conditional access mechanism 800 may thus be realized as a policy assertion that comports with a form of:

```
assertor says principal access resource if principal possess
        {(attribute name₁, attribute value₁), (attribute name₂,
        attribute value₂), ..., (attribute nameₛ, attribute valueₛ)} .
```

In the policy assertion above, fact portion 508 corresponds to principal access resource. The policy assertion above indicates that the assertor believes that the principal should be granted access to the resource if the principal possesses each of the “s” specified attribute values of the “s” identified attribute names.

In other words, with conditional access mechanism 800, the validity of fact 508 is conditioned on whether or not principal 502 simultaneously possesses each name-value pair 604* of attribute set 604(s). If principal 502 does possess each predetermined attribute, the fact is deduced to be valid. Hence, access to the requested resource can be granted. If principal 502 does not simultaneously possess each predetermined attribute, the fact cannot be deduced to be valid. Hence, access to the requested resource is denied (i.e., access is not granted based on this policy assertion).

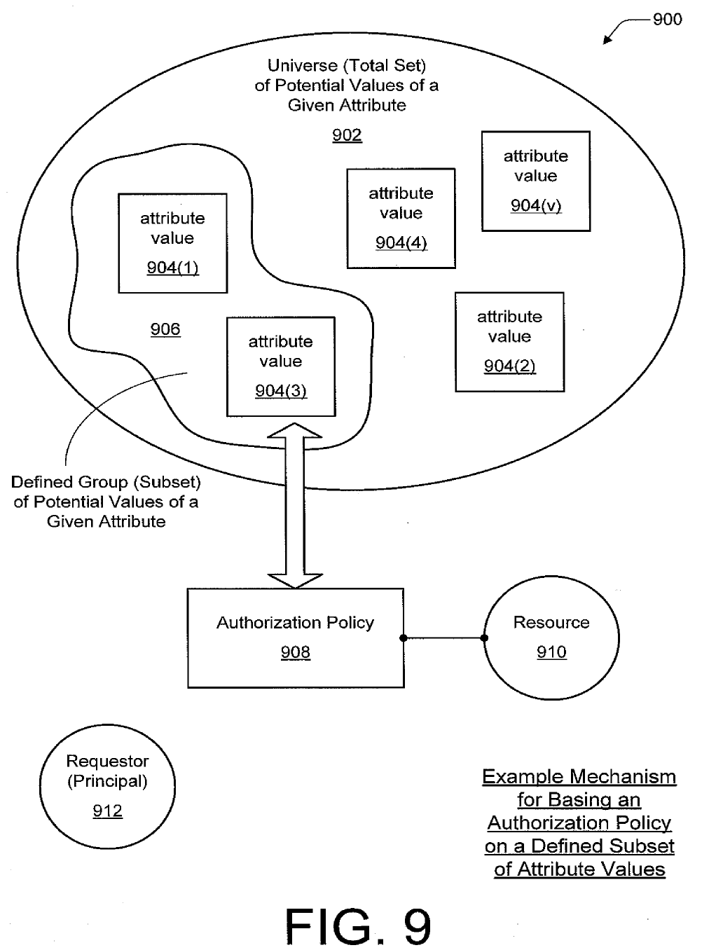

FIG. 9 is a block diagram illustrating an example mechanism 900 for basing an authorization policy on a defined subset of attribute values. A given attribute has a universe (or total set) 902 of potential values. The block diagram of FIG. 9 also includes a defined group (or subset) 906 of potential values of the given attribute, an authorization policy 908, a resource 910, and a requester (e.g., a principal) 912.

As illustrated, total set of potential values 902 includes “v” attribute values 904, with “v” being some integer. Specifically, total set of potential values 902 includes: attribute value 904(1), attribute value 904(2), attribute value 904(3), attribute value 904(4), . . . . , attribute value 904(v). Each attribute value 904 is a value instance that may be assigned to a given attribute name. Defined subset of values 906 includes two attribute values: attribute value 904(1) and attribute value 904(3). However, a defined subset of values 906 may generally include any number of attribute values 904.

In a described implementation, authorization policy 908 defines subset of values 906 from total set of potential values 902. Authorization policy 908 is directed to resource 910 (e.g., resource 110 of FIGS. 1-3). Authorization policy 908 stipulates that access to resource 910 requires that requestor 912 possess any one or more of the attribute values 904 that are grouped into defined subset of values 906.

When requester 912 submits a resource access request directed to resource 910, authorization policy 908 enforces the requirement that a principal hold at least one attribute value from among defined subset of values 906. Hence, if requestor 912 possesses attribute value 904(1) and/or attribute value 904(3), requestor 912 may be granted access to resource 910. If requester 912 does not possess either of attribute value 904(1) or attribute value 904(3), access to resource 910 is denied to requestor 912 under authorization policy 908, even if requester 912 possesses every other attribute value 904 of total set of values 902.

Thus, conditional access is provided based on whether a principal possesses one or more attribute values of a defined subset of potential values of a given attribute. An example policy assertion for such conditional access may be expressed in a form that comports with:

```
assertor says principal access resource if principal possess
        given_attribute=group and group matches
        (defined_subset_of_values) ,
```

wherein the “principal” corresponds to requestor 912, “resource” corresponds to resource 910, and “defined_subset_of_values” corresponds to defined subset of values 906.

Thus, this scoping of authorized behavior can be integrated into a policy assertion. Consequently, grouping relationships can be efficiently expressed based on a single attribute type. Given known groups A, B, C, and D, for example, a policy writer can make a first fact dependent on a second fact, with the second fact comporting with a form such as “x possess group name=g and g matches (A|B)”. This effectively declares that groups A and B are equivalent to each other with respect to this policy.

Attributes can also be integrated into a policy assertion using patterns describing a subset of the universe of possible values for a given attribute type. For example, access to a resource may be dependent on a principal possessing a group attribute which matches a known value format, such as a known project value format. A pattern expressing this can be defined using any of a number of mechanisms (e.g., regular expressions, XPath expressions, and so on). If the project values to match are of the form ‘Project/<alpha-numeric project name>’, then an appropriate regular expression pattern for this group attribute is group=g{Project/[A-Za-z0-9]+$}. This implies that the variable g may take on any value which matches the regular expression inside the braces. In this manner, access to a resource may be based on a specific variable being capable of binding to a general set of attribute values where the possible value instances are not completely specified when the policy is written.

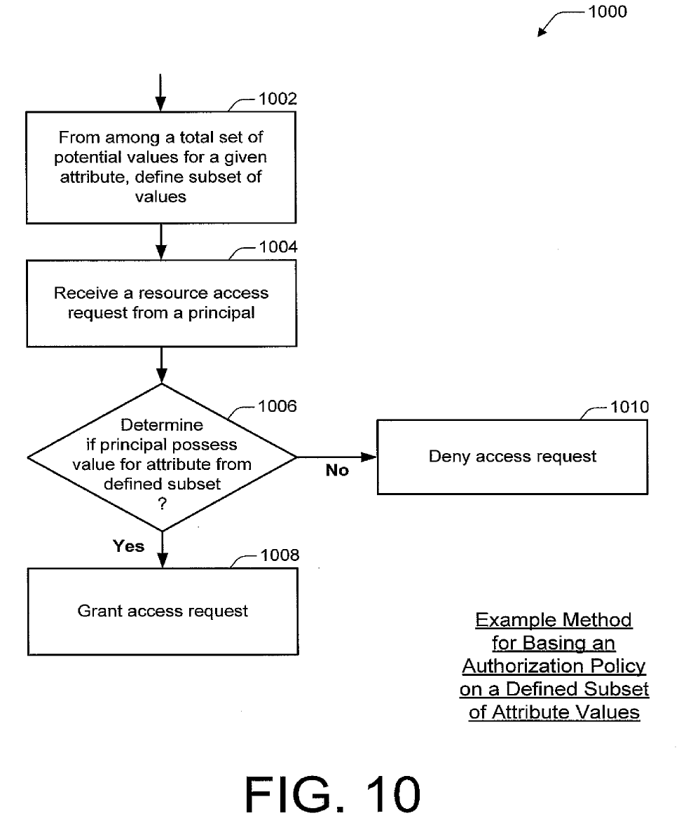

FIG. 10 is a flow diagram 1000 that illustrates an example of a method for basing an authorization policy on a defined subset of attribute values. Flow diagram 1000 includes five (5) blocks 1002-1010. Although the actions of flow diagram 1000 may be performed in other environments and with a variety of hardware/software/firmware combinations, some of the features, components, and aspects of FIGS. 1-9 are used to illustrate an example of the method. For example, the actions may be performed by security policy module 220, authorization engine 218, and/or resource guard 214, etc. using mechanism 900.

In a described implementation, at block 1002, a subset of values is defined from among a total set of potential values for a given attribute. For example, for an authorization policy 908 on a resource 910, a subset of values 906 may be defined from among a total set of potential values for a given attribute 902.

At block 1004, a resource access request is received from a principal. For example, an access request from a principal 912 that is directed to resource 910 may be received.

At block 1006, it is determined if the principal possesses at least one value for the given attribute that is included as part of the defined subset of values. For example, it may be determined if principal 912 possesses attribute value 904(1) and/or attribute value 904(3) (e.g., by analyzing one or more token assertions presented along with the access request).

If it is determined (at block 1006) that the principal possesses at least one value from the defined subset of values, then at block 1008 the access request is granted. Otherwise, the access request is denied at block 1010.

The devices, actions, aspects, features, functions, procedures, modules, data structures, protocols, components, etc. of FIGS. 1-10 are illustrated in diagrams that are divided into multiple blocks. However, the order, interconnections, interrelationships, layout, etc. in which FIGS. 1-10 are described and/or shown are not intended to be construed as a limitation, and any number of the blocks can be modified, combined, rearranged, augmented, omitted, etc. in any manner to implement one or more systems, methods, devices, procedures, media, apparatuses, APIs, protocols, arrangements, etc. for authorization decisions with principal attributes.

Although systems, media, devices, methods, procedures, apparatuses, mechanisms, schemes, approaches, processes, arrangements, and other implementations have been described in language specific to structural, logical, algorithmic, and functional features and/or diagrams, it is to be understood that the invention defined in the appended claims is not necessarily limited to the specific features or acts described above. Rather, the specific features and acts described above are disclosed as example forms of implementing the claims.

What is claimed is:

1. A system implementing a security scheme having a unified principal-to-attribute binding mechanism, the system comprising token assertions that can utilize the unified principal-to-attribute binding mechanism and policy assertions that can utilize the unified principal-to-attribute binding mechanism.

2. The system as recited in claim 1, wherein the token assertions are used by resource access requestors to provide authentication, and wherein policy assertions are used by resource protectors to indicate access rights to resources.

3. The system as recited in claim 1, wherein the unified principal-to-attribute binding mechanism comprises a fact that comports with a form of:
principal possess-verb attribute-object.

4. The system as recited in claim 3, wherein the attribute-object portion of the principal-to-attribute binding mechanism can comprise a single attribute or an attribute set.

5. The system as recited in claim 3, wherein the attribute-object is encoded as at least one name-value pair.

6. The system as recited in claim 1, wherein each token assertion that includes a principal-to-attribute binding mechanism comprises a statement indicating that an asserter believes a principal-to-attribute binding to be true; and wherein each policy assertion that includes a principal-to-attribute binding mechanism comprises a statement indicating that a fact is true if a particular principal-to-attribute binding is true.

7. The system as recited in claim 1, wherein each principal-to-attribute binding mechanism is capable of expressing a binding between a principal and an attribute; and wherein the attribute is selected from a group of attributes comprising: email name, common name, group name, role title, account name, domain name server/service (DNS) name, internet protocol (IP) address, device name, application name, organization name, service name, and account identification/identifier (ID).

8. The system as recited in claim 1, wherein the security scheme further enables a given authorization policy to be declared equivalently valid for principals possessing any one or more attribute values from among a group of defined attribute values.

9. A device that protects a resource and provides conditional access to the resource based on a principal simultaneously possessing multiple predetermined attributes.

10. The device as recited in claim 9, wherein the device enforces an authorization policy indicating that the principal can access the resource if the principal possesses at least a first predetermined attribute and a second predetermined attribute.

11. The device as recited in claim 10, wherein the authorization policy utilizes a unified principal-to-attribute binding mechanism; and wherein the device processes token assertions that utilize the unified principal-to-attribute binding mechanism.

12. The device as recited in claim 10, wherein the device attempts to deduce one or more valid assertions that indicate that the principal possesses the first predetermined attribute and that the principal possesses the second predetermined attribute.

13. The device as recited in claim 9, wherein the conditional access is expressed in an assertion that comports with a form of:
```
assertor says principal access resource if principal possess
        {(attribute name₁, attribute value₁), (attribute name₂,
        attribute value₂), ..., (attribute nameₛ, attribute valueₛ)} ,
```
where “s” represents an integer of two or greater.

14. The device as recited in claim 9, wherein one or more of the multiple predetermined attributes is defined by a group of attributes in which a subset of a universe of possible values for a given attribute is described using at least one pattern.

15. The device as recited in claim 9, wherein the device further provides conditional access based on whether a principal possesses one or more attribute values of a defined subset of potential values of a given attribute.

16. A method comprising:
for an authorization policy on a resource, defining a subset of values from among a total set of potential values for a given attribute, the defined subset of values including at least two values;
receiving an access request from a principal that is directed to the resource;
in response to the access request, determining if the principal possesses at least one value that is included in the defined subset of values for the given attribute; and
if the principal is determined to possess at least one value that is included in the defined subset of values for the given attribute, granting the principal access to the resource.

17. The method as recited in claim 16, further comprising:
if the principal is not determined to possess at least one value that is included in the defined subset of values for the given attribute, denying the principal access to the resource.

18. The method as recited in claim 16, wherein the defining, the determining, and the granting are performed based on at least one policy assertion created for the authorization policy.

19. The method as recited in claim 18, wherein the at least one policy assertion is expressed in a form that comports with:
```
assertor says principal access resource if principal possess
        given_attribute=group and group matches
        (defined_subset_of_values) ,
```
wherein the given attribute corresponds to “given_attribute” and the defined subset of values for the given attribute corresponds to “defined _subset_of_values”.

20. The method as recited in claim 16, further comprising:
establishing multiple attributes that a principal must simultaneously possess to be granted access to another resource;
receiving from another principal another access request that is directed to the other resource;
in response to the other access request, determining if the other principal simultaneously possesses each attribute multiple attributes; and
if the other principal is determined to simultaneously possesses each attribute of the multiple attributes, granting the other principal access to the other resource, otherwise denying access to the other resource.
